(19) United States
(12) Patent Application Publication
(10) Pub. No.: US 2011/0217988 A1
(43) Pub. Date: Sep. 8, 2011

(54) MOBILE DEVICE HAVING AUXILIARY POWER SUPPLY UNIT FOR TRANSMISSION OF LOCATION INFORMATION AND RELATED METHOD

(75) Inventors: Young Heo, Yongin-si (KR); Key Jeong, Suwon-si (KR); Hyun Hoon Ha, Osan-si (KR)

(73) Assignee: SAMSUNG ELECTRONICS CO., LTD., Suwon-si (KR)

(21) Appl. No.: 13/040,091

(22) Filed: Mar. 3, 2011

(30) Foreign Application Priority Data
Mar. 3, 2010 (KR) 10-2010-0019038

(51) Int. Cl. H04W 4/00

(52) U.S. Cl. 455/456.1

(57) ABSTRACT

A mobile device has a radio frequency (RF) unit that transmits location information about the mobile device to a base station. The mobile device includes a main power supply unit that supplies main electric power to respective elements of the mobile device, and an auxiliary power supply unit that supplies auxiliary electric power to selected elements of the mobile device when the main electric power is not supplied. A switch unit connects the auxiliary power supply unit with the selected elements when the main electric power is not supplied. A control unit controls operation of the switch unit by detecting when the main electric power is not supplied and controls transmission of the location information to the base station through the RF unit. Even when the main electric power is not supplied, the mobile device can repeatedly transmit its location information to the base station by using auxiliary electric power.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on Mar. 3, 2010 and assigned Serial No. 10-2010-0019038, the entire disclosure of which is hereby incorporated by reference.

### TECHNICAL FIELD OF THE INVENTION

The present invention relates in general to a mobile device and, more particularly, to a mobile device and method in which an auxiliary power supply unit is enabled to supply auxiliary electric power to selected elements of the mobile device when main electric power is not supplied and, thereby, location information about the mobile device is repeatedly transmitted to a base station.

### BACKGROUND OF THE INVENTION

With the advent of new techniques and functions arousing consumer interest, the market of mobile devices is making a rapid and strong growth. Moreover, dramatic advances in mobile communication technology are improving traditional mobile devices with a variety of functions and applications that meet customers' demands. Accordingly, users of mobile devices come to use information in various forms of voice, text, images, and such, and to enjoy music, broadcast, game, and such.

In particular, an SOS function has been introduced into recent mobile devices. In an emergency situation, this SOS function allows a mobile device to send its location information to an emergency center or other pre-registered devices through a location tracking technique. Anyone who carries such a mobile device can benefit from receiving help quickly and easily.

In addition, a typical SOS function is available only while electric power is being supplied in the mobile device. If a power supply unit (i.e., a battery) of the mobile device is electrically discharged or physically detached, a base station may fail to accurately find the location of the mobile device, and hence the SOS function may not operate.

Therefore, even though electric power is not supplied, the mobile device needs to continuously keep a connection with a base station such that the base station can always ascertain the location of the mobile device.

### SUMMARY OF THE INVENTION

To address the above-discussed deficiencies of the prior art, it is a primary object to provide a mobile device and related method for continuously keeping a connection with a base station to allow the base station to always find the location of the mobile device even when main electric power is not supplied in the mobile device.

According to one aspect of the present invention, provided is a mobile device for periodically transmitting location information to a base station. The mobile device includes a radio frequency (RF) unit configured to transmit the location information about the mobile device to a base station. A main power supply unit is configured to supply main electric power to respective elements of the mobile device. An auxiliary power supply unit is configured to supply auxiliary electric power to selected elements of the mobile device when the main electric power is not supplied. A switch unit is configured to connect the auxiliary power supply unit with the selected elements when the main electric power is not supplied. And a control unit is configured to control operation of the switch unit by detecting when the main electric power is not supplied and control transmission of the location information to the base station through the RF unit.

According to another aspect of the present invention, a method in a mobile device for periodically transmitting location information about the mobile device to a base station is provided. The method includes determining whether main electric power is not supplied. If the main electric power is not supplied, an auxiliary power supply unit is coupled to selected elements of the mobile device such that auxiliary electric power is supplied to the selected elements. And the location information is transmitted to the base station by using the auxiliary electric power.

According to yet another aspect of the invention, a method in a mobile device periodically transmits location information about the mobile device to a base station. When a location tracking function is established in the mobile device, an auxiliary power supply unit is coupled to selected elements of the mobile device such that auxiliary electric power is supplied to the selected elements upon determining that the main electric power is not supplied. When the auxiliary power supply unit is coupled to the selected elements, the location information is transmitted to the base station by using the auxiliary electric power.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic diagram illustrating a problem of a conventional SOS function.

FIG. 2 illustrates a schematic diagram of a new concept in which a mobile device maintains a connection with a base station even though main electric power is not supplied in accordance with an embodiment of the present invention.

FIG. 3 illustrates the configuration of a mobile device in accordance with an embodiment of the present invention.

FIG. 4 illustrates a process for transmitting location information about a mobile device by using auxiliary electric power when main electric power is not supplied in accordance with an embodiment of the present invention.

FIG. 5 is a graph illustrating variations of electric current consumed while a mobile device repeatedly transmits its location information to a base station in accordance with an embodiment of the present invention.

### DETAILED DESCRIPTION OF THE INVENTION

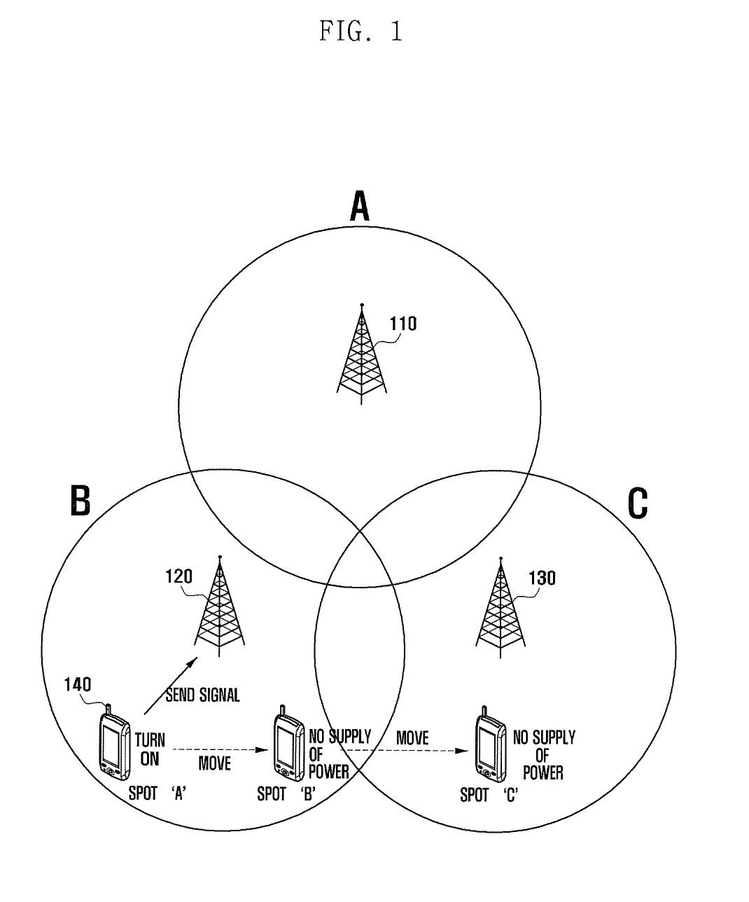

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. This invention may, however, be embodied in many different forms and should not be construed as limited to the embodiments set forth herein. Rather, the disclosed embodiments are provided such that this disclosure will be thorough and complete, and will fully convey the scope of the invention to those skilled in the art. The principles and features of this invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent embodiments of the invention, the drawings are not necessarily to scale and certain features may be exaggerated or omitted in order to better illustrate and explain the present invention.

According to embodiments of this invention, main electric power may be not supplied in a mobile device due to several unintended or intended causes such as cutoff, discharge and detachment of a main power supply unit.

Location information that a mobile device offers to a base station may be actual location information about the mobile device or any kind of signal that allows the base station to ascertain the location of the mobile device. In one embodiment of this invention, GPS (Global Positioning System)-based location information may be preferably used as actual location information about the mobile device. In another embodiment, a control signal used to establish an initial connection with the base station during a booting process of the mobile device may be alternatively used for obtaining location information about the mobile device.

FIG. 1 is a schematic diagram illustrating a problem of a conventional SOS function.

As shown in FIG. 1, a mobile communication network is normally composed of a plurality of base stations 110, 120, and 130, each of which has a specific coverage A, B, or C. One base station 110 provides a communication service to mobile devices located in the coverage A, another base station 120 provides a communication service to mobile devices located in the coverage B, and still another base station 130 provides a communication service to mobile devices located in the coverage C.

If a certain mobile device connected to the base station 110 gets out of the coverage A and enters into the coverage B, the mobile device removes a current connection from the base station 110 and then tries to establish a new connection with the base station 120. This is well known as handover or handoff in the art.

After connecting to the base station 120, the mobile device 140 periodically transmits its location information to the base station 120. The base station 120 obtains the received location information about the mobile device 140 and reports it to a higher-layer entity. The mobile device 140 continuously sends location information to the base station 120 while electric power is supplied, and the base station 120 updates location information about the mobile device whenever receiving it from the mobile device 140.

However, if main electric power is not supplied, the mobile device 140 cannot send its location information to the base station 120. Therefore, the base station 120 fails to accurately ascertain the location of the mobile device 140. For example, let's suppose that the mobile device 140 lastly sends location information at the spot ‘A’ and main electric power is no longer supplied after the mobile device 140 moves to the spot ‘B’. In this situation, even though the actual location of the mobile device 140 is the spot ‘B’, the lastly reported location of the mobile device 140 is the spot ‘A’. Therefore, the base station 120 wrongly understands that the mobile device 140 is located at the spot ‘A’.

As discussed above, many recent mobile devices have an SOS function. However, if the base station 120 fails to find an accurate location of the mobile device 140 due to lack of electric power of the mobile device 140, such an SOS function may not be helpful. Especially, when the mobile device 140 gets out of a current coverage (e.g., coverage B) and then enters into another coverage (e.g., coverage C), an error in location of the mobile device 140 may become serious.

Accordingly, this invention proposes a way to allow the base station to continuously find the location of the mobile device 140 by maintaining a connection between the mobile device 140 and the base station even though main electric power is not supplied to the mobile device 140.

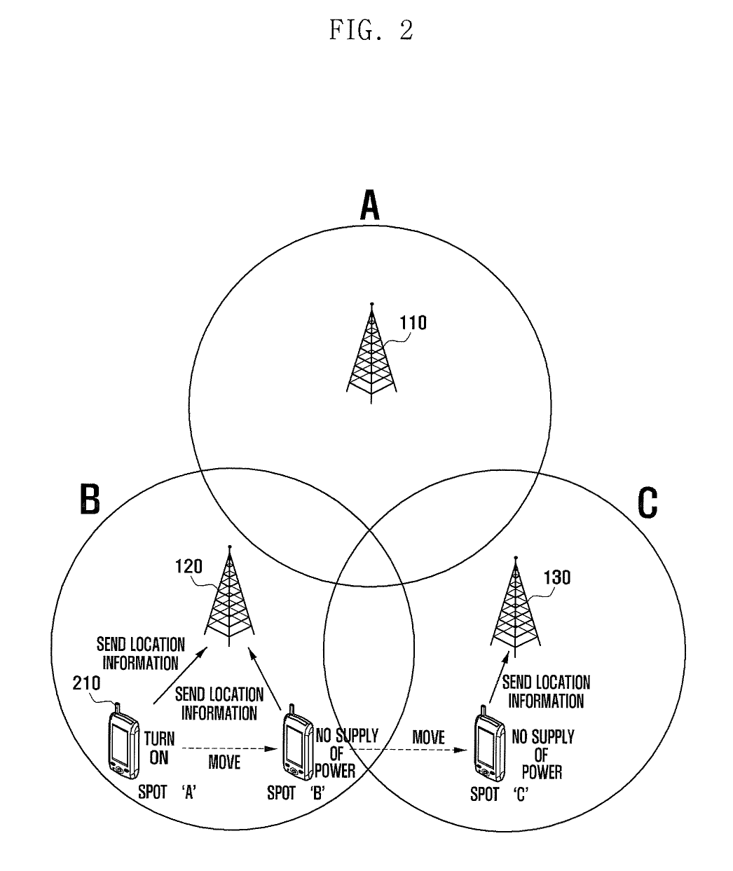

FIG. 2 illustrates a schematic diagram of a new concept in which a mobile device maintains a connection with a base station even though main electric power is not supplied in accordance with an embodiment of the present invention.

As shown in FIG. 2, let's suppose that a mobile device 210 is turned on at the spot ‘A’ and is initially connected to the base station 120. The mobile device 210 periodically sends its own location information to the base station 120. The base station 120 receives location information from the mobile device 210 and updates location information about the mobile device 210.

Thereafter, let's suppose that electric power is no longer supplied in the mobile device 210 after the mobile device 210 moves from the spot ‘A’ to the spot ‘A’. According to a prior art, after electric power is not supplied, the mobile device 210 may no longer send its location information to the base station 120. Therefore, the base station 120 fails to accurately find the location of the mobile device 210.

However, according to an embodiment of this invention, the mobile device 210 can maintain a connection with the base station 120 regardless of no supply of main electric power and, thereby, can transmit its location information to the base station 120. Therefore, the base station 120 can continuously update location information about the mobile device 210. In addition, if the mobile device 210 gets out of a current coverage (e.g., coverage B) and then enters into other coverage (e.g., coverage C), the mobile device 210 can try to establish a new connection with another base station 130 even though main electric power is not supplied. Accordingly, a mobile communication system can always ascertain the location of the mobile device 210 regardless of no supply of electric power in the mobile device 210.

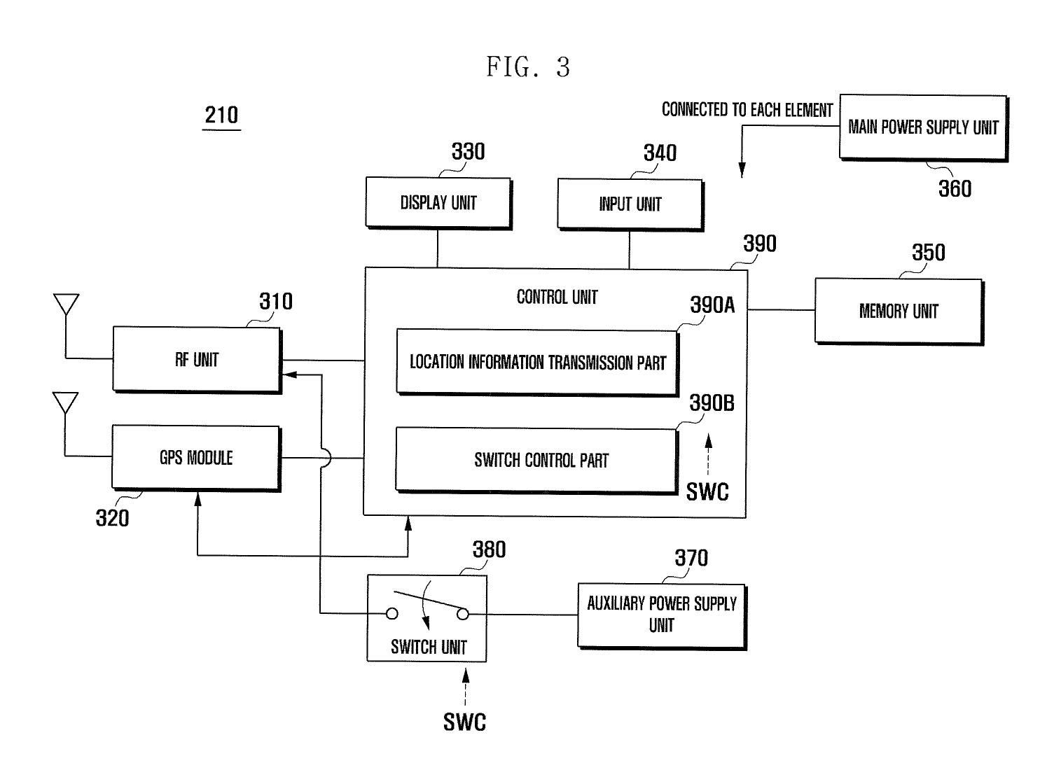

FIG. 3 illustrates a configuration of a mobile device in accordance with an embodiment of the present invention.

Referring to FIG. 3, the mobile device 210 of this invention may include a radio frequency (RF) unit 310, a GPS module 320, a display unit 330, an input unit 340, a memory unit 350, a main power supply unit 360, an auxiliary power supply unit 370, a switch unit 380, and a control unit 390. Additionally, the control unit 390 may include a location information transmission part 390A and a switch control part 390B.

The RF unit 310 sends and receives data in a wireless communication of the mobile device 210. Normally, the RF unit 310 may include an RF transmitter that up-converts the frequency of an outgoing signal and then amplifies the signal, an RF receiver that amplifies an incoming signal with low-noise and down-converts the frequency of the signal, and such. Additionally, the RF unit 310 may receive data through a wireless channel and then output it to the control unit 390, and also may transmit data outputted from the control unit 390 through a wireless channel. Particularly, the RF unit 310 may send location information about the mobile device 210 to the base station.

The GPS module 320 may include or be connected to a GPS receiver. The GPS module 320 obtains a GPS signal for determining a location from GPS satellites through the GPS receiver. The mobile device 210 of this invention may optionally include the GPS module 320. Some embodiments may not include the GPS module 320.

The display unit 330 may be formed of LCD (Liquid Crystal Display), OLED (Organic Light Emitting Diode) or any other equivalent. The display unit 330 visually displays a menu, data entered, function setting information, and any other various information of the mobile device 210. For example, the display unit 330 may display a booting screen, an idle screen, a menu screen, a call screen, a setting screen, a specific application execution screen, and such.

The input unit 340 creates an input signal corresponding to a user's manipulation for controlling the mobile device 210 and then sends the input signal to the control unit 390. The input unit 340 may be formed of a keypad that includes alphanumeric keys and navigation keys and may further include function keys arranged on sides of the mobile device 210. In some embodiments of this invention, the input unit 340, together with the display unit 330, may be formed of a touch screen.

The memory unit 350 stores programs and data for operations of the mobile device 210. The memory unit 350 may consist of a program region and a data region. The program region stores an operating system (OS) of the mobile device, a program for forming an idle screen, and any other programs for various optional functions such as a camera, a sound output, an image view, a video play, and such. When such a function is activated in response to a user's request, the mobile device 210 offers the requested function by using a suitable program.

The data region stores a variety of data produced or used while the mobile device 210 operates. The data region may store various contents transferred or copied from an external memory or a hard disk or downloaded from a web server in a wired or wireless internet network. Also, the data region may store end-user functions related to various optional functions, such as an image, video or audio file by a camera function.

In particular, the memory unit 350, according to an embodiment of this invention, may store a program that allows the auxiliary power supply unit 370 to supply auxiliary electric power to the mobile device 210 when main electric power is not supplied.

The main power supply unit 360 supplies main electric power to respective elements of the mobile device 210.

The auxiliary power supply unit 370 supplies auxiliary electric power to selected elements for transmission of location information about the mobile device 210 when the main power supply unit 360 fails to supply main electric power. The auxiliary power supply unit 370 may be equipped in or attached to the mobile device 210. In some embodiments of this invention, the auxiliary power supply unit 370 may supply auxiliary electric power to the RF unit 310, the GPS module 320 and the control unit 390 when main electric power is not supplied by the main power supply unit 360.

The reason for supplying auxiliary electric power to the RF unit 310 is to transmit location information about the mobile device 210 to the base station. The reason for supplying auxiliary electric power to the GPS module 320 is to receive location information from GPS satellites when the mobile device 210 includes the GPS module 320. Because the GPS module 320 generally includes a receiving part without a transmitting part, the received GPS location information is transmitted through the RF unit 310. The reason for supplying auxiliary electric power to the control unit 390 is to perform a signal processing for location information to be transmitted to the base station.

The switch unit 380 connects the auxiliary power supply unit 370 with selected elements of the mobile device 210 such that auxiliary electric power may be supplied to the connected elements when main electric power is not supplied. In some embodiments of this invention, the switch unit 380 may allow the auxiliary power supply unit 370 to supply auxiliary electric power to the selected elements of the mobile device 210, depending on a switch control signal.

The control unit 390 controls signal flows between respective blocks of the mobile device 210. In particular, when a location tracking function is established in the mobile device 210, the control unit 390 controls a prearranged procedure of periodically transmitting location information about the mobile device 210 to the base station. Also, although not illustrated in the drawings, the control unit 390 may include an upload traffic processor and a download traffic processor.

The upload traffic processor may include a coder for encoding a signal (e.g., location information) to be transmitted, a modulator for modulating the encoded signal, and a digital-analog convertor for converting the modulated signal into an analog signal. The coder may have a data coder for processing packet data, and such, and an audio coder for processing an audio signal such as a voice. The upload traffic processor outputs the encoded and modulated signal to the RF unit 310.

The download traffic processor may include an analog-digital convertor for converting an analog signal into a digital signal, a demodulator for demodulating the modulated signal, and a decoder for decoding the demodulated signal. The decoder may have a data decoder for processing packet data, and such, and an audio decoder for processing an audio signal such as a voice.

The control unit 390 according to an embodiment of this invention may have the location information transmission part 390A and the switch control part 390B.

The location information transmission part 390A controls a series of process for transmitting location information about the mobile device 210 to a nearby base station. As discussed above, location information may be actual location information about the mobile device 210 or any kind of signal that allows the base station to ascertain the location of the mobile device. In one embodiment of this invention, a GPS signal of the mobile device 210 may be used as actual location information. In another embodiment, a control signal used to establish an initial connection with the base station during a booting process of the mobile device may be alternatively used for obtaining location information about the mobile device. The location information transmission part 390A controls periodic transmission of location information to the base station.

Meanwhile, even though main electric power is not supplied by the main power supply unit 360, the location information transmission part 390A may perform a process for transmitting location information to the base station by using auxiliary electric power supplied by the auxiliary power supply unit 370.

In an embodiment of this invention, when auxiliary electric power is supplied by the auxiliary power supply unit 370, the location information transmission part 390A may increase a transmission period of location information in comparison with a predefined normal period in order to reduce power consumption.

The switch control part 390B generates a switch control signal (SWC) such that the auxiliary power supply unit 370 can supply auxiliary electric power to selected elements of the mobile device 210 when the main power supply unit 360 fails to supply main electric power. Then the switch unit 380 receives the switch control signal from the switch control part 390B and connects the auxiliary power supply unit 370 with selected elements of the mobile device 210 in order to allow the supply of auxiliary electric power.

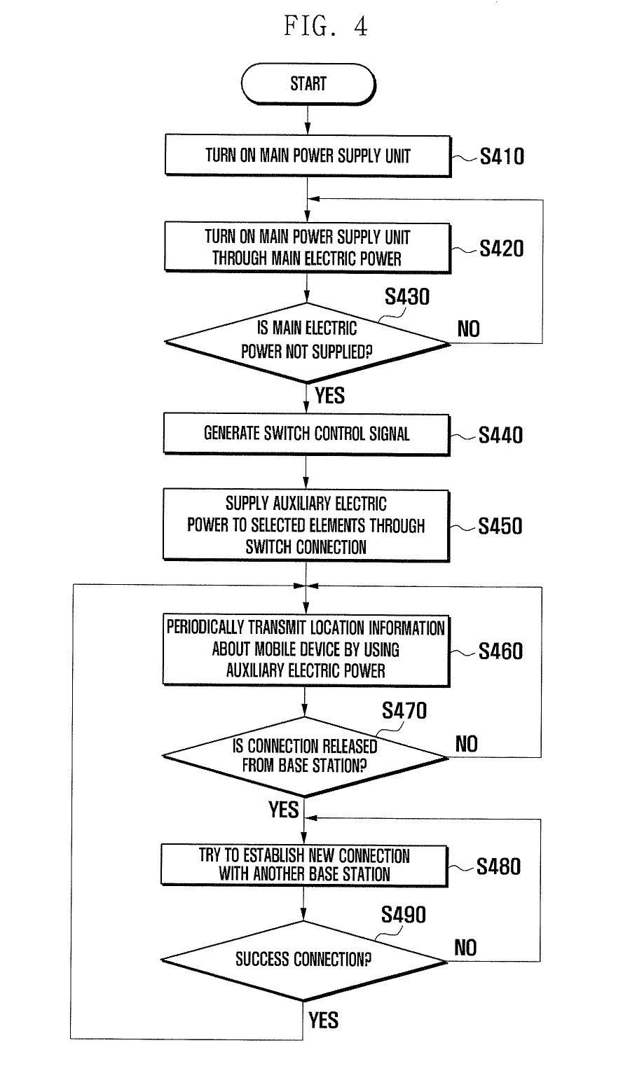

FIG. 4 illustrates a process for transmitting location information about a mobile device by using auxiliary electric power when main electric power is not supplied in accordance with an embodiment of the present invention.

Referring to FIG. 4, at the outset, the control unit 390 turns on the main power supply unit 360 of the mobile device 210 (block S410). Then the control unit 390 determines whether a location tracking function is established in the mobile device 210 and, if so, performs a prearranged procedure to be described hereinafter.

Next, the control unit 390 controls respective elements of the mobile device 210 such that they may be driven through main electric power supplied by the main power supply unit 360 (block S420).

Next, the control unit 390 determines whether the main power supply unit 360 fails to supply main electric power (block S430). As discussed above, main electric power may not be supplied in a mobile device due to several unintended or intended causes such as cutoff, discharge, and detachment of the main power supply unit 360. If the main power supply unit 360 successfully supplies main electric power, the control unit 390 returns to the previous block 5420 earlier discussed.

The switch control part 390B detects when the main power supply unit 360 does not supply main electric power, and generates a switch control signal that allows the auxiliary power supply unit 370 to supply auxiliary electric power to selected elements of the mobile device 210 (block S440).

Then the switch unit 380 receives the switch control signal from the switch control part 390B and connects the auxiliary power supply unit 370 with selected elements of the mobile device 210 such that the auxiliary power supply unit 370 can supply auxiliary electric power to the selected elements (block S450). In an embodiment of this invention, the auxiliary power supply unit 370 may supply auxiliary electric power to the RF unit 310, the GPS module 320, and the control unit 390.

Therefore, even though main electric power is not supplied by the main power supply unit 360, the location information transmission part 390A may periodically transmit location information about the mobile device 210 to the base station by using auxiliary electric power (block S460). In an embodiment of this invention, the location information transmission part 390A may increase a transmission period of location information in comparison with a predefined normal period in order to reduce power consumption.

Meanwhile, the control unit 390 may determine whether a connection is released from a current base station (block S470). If a current connection is not released, the control unit 390 returns to the previous block 5460 and periodically sends location information about the mobile device 210 to the base station.

If a current connection is released, the control unit 390 tries to establish a new connection with another base station (block S480). If a new connection is successfully made, the control unit 390 returns to the previous block 5460 and periodically sends location information about the mobile device 210 to the base station.

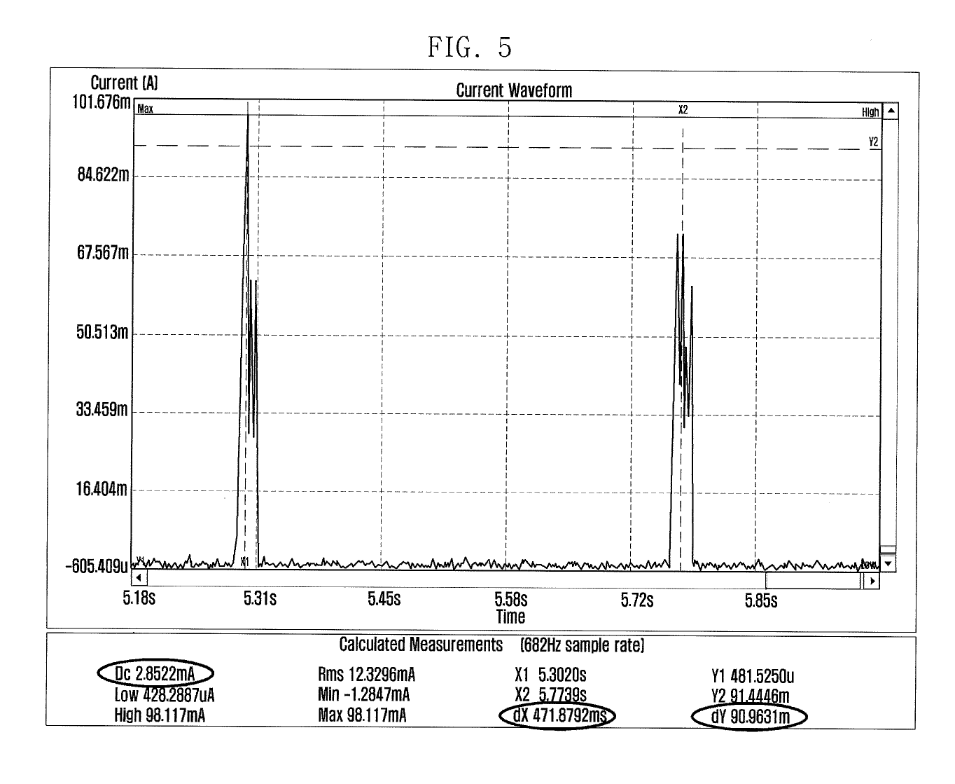

FIG. 5 is a graph illustrating variations of electric current consumed while a mobile device repeatedly transmits its location information to a base station in accordance with an embodiment of the present invention.

As shown in FIG. 5, the mobile device sends its location information to the base station periodically (e.g., about every 472 ms). Normally electric current of about 90 mA is consumed during transmission of location information, whereas electric current of about 3 mA is consumed during non-transmission.

As seen in FIG. 5, electric current consumed for transmitting location information is insignificant. Therefore, although the auxiliary power supply unit 370 has a relatively smaller capacity than the main power supply unit 360, the mobile device 210 can periodically transmit location information to the base station by using auxiliary electric power for a considerable time. Besides, if a transmission period of location information is increased, a total time available for transmission of location information by using only auxiliary electric power becomes much greater.

As discussed hereinbefore, even when main electric power is not supplied, the mobile device according to this invention can repeatedly transmit its location information to the base station by using auxiliary electric power.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A mobile device for periodically transmitting location information to a base station, the mobile device comprising:
a radio frequency (RF) unit configured to transmit the location information about the mobile device to the base station;
a main power supply unit configured to supply main electric power to respective elements of the mobile device;
an auxiliary power supply unit configured to supply auxiliary electric power to selected elements of the mobile device when the main electric power is not supplied;
a switch unit configured to couple the auxiliary power supply unit to the selected elements when the main electric power is not supplied; and
a control unit configured to control operation of the switch unit by detecting when the main electric power is not supplied and also to control transmission of the location information to the base station through the RF unit.

2. The mobile device of claim 1, further comprising:
a global positioning system (GPS) module configured to receive a GPS signal from a GPS satellite,
wherein the control unit is further configured to control transmission of the GPS signal as the location information to the base station.

3. The mobile device of claim 1, wherein the switch unit is further configured to couple the auxiliary power supply unit to the RF unit and the control unit when the main electric power is not supplied.

4. The mobile device of claim 2, wherein the switch unit is further configured to couple the auxiliary power supply unit to the RF unit, the GPS module and the control unit when the main electric power is not supplied.

5. The mobile device of claim 1, wherein the control unit is further configured to increase a transmission period of the location information in comparison with a predefined normal period.

6. The mobile device of claim 1, wherein the control unit is further configured to determine whether a location tracking function is established in the mobile device and control the operation of the switch unit in response to determining that the location tracking function is established and detecting that the main electric power is not supplied.

7. The mobile device of claim 1, wherein the control unit is further configured to determine whether the mobile device is connected to the base station.

8. The mobile device of claim 7, wherein the control unit is further configured to attempt to establish a new connection with another base station in response to determining that the mobile device is disconnected from the base station.

9. The mobile device of claim 7, wherein the RF unit is further configured to transmit the location information in response to determining that the mobile device is connected to the base station.

10. A method in a mobile device for periodically transmitting location information about the mobile device to a base station, the method comprising:
determining whether main electric power is not supplied;
in response to determining that the main electric power is not supplied, coupling an auxiliary power supply unit to selected elements of the mobile device such that auxiliary electric power is supplied to the selected elements; and
transmitting the location information to the base station by using the auxiliary electric power.

11. The method of claim 10, wherein transmitting the location information comprises transmitting a global positioning system (GPS) signal as the location information to the base station, the GPS signal being received from a GPS satellite.

12. The method of claim 10, wherein the selected elements comprise components used to transmit the location information to the base station.

13. The method of claim 11, wherein the selected elements comprise components used to receive the GPS signal and transmit the GPS signal to the base station.

14. The method of claim 10, wherein transmitting the location information comprises increasing a transmission period of the location information in comparison with a predefined normal period.

15. The method of claim 10, further comprising:
determining whether a location tracking function is established in the mobile device,
wherein the location information is transmitted to the base station by using the auxiliary electric power in response to determining that the location tracking function is established and the main electric power is not supplied.

16. The method of claim 10, further comprising determining whether the mobile device is connected to the base station.

17. The method of claim 11, further comprising attempting to establish a new connection to another base station in response to determining that the mobile device is disconnected from the base station.

18. The method of claim 11, wherein the location information is transmitted to the base station in response to determining that the mobile device is connected to the base station.

19. A method in a mobile device for periodically transmitting location information about the mobile device to a base station, the method comprising:
when a location tracking function is established in the mobile device, coupling an auxiliary power supply unit to selected elements of the mobile device such that auxiliary electric power is supplied to the selected elements in response to determining that the main electric power is not supplied; and
when the auxiliary power supply unit is coupled to the selected elements, transmitting the location information to the base station by using the auxiliary electric power.

20. The method of claim 19, wherein the selected elements comprise components used to transmit the location information to the base station.
